(19) United States
(12) Patent Application Publication
(10) Pub. No.: US 2021/0168279 A1
(43) Pub. Date: Jun. 3, 2021

(54) DOCUMENT IMAGE CORRECTION METHOD AND APPARATUS

(71) Applicant: HUAWEI TECHNOLOGIES CO., LTD., Shenzhen (CN)

(72) Inventors: Wenmei GAO, Beijing (CN); Guowei OUYANG, Beijing (CN); Yunchao ZHANG, Beijing (CN)

(73) Assignee: HUAWEI TECHNOLOGIES CO., LTD., Shenzhen (CN)

(21) Appl. No.: 16/497,727

(22) PCT Filed: Apr. 19, 2017
(86) PCT No.: PCT/CN2017/081146

§ 371 Date: Sep. 25, 2019

(30) Foreign Application Priority Data
Apr. 6, 2017 (CN) 201710222059.9

(51) Int. Cl. H04N 5/232

(52) U.S. Cl. CPC H04N 5/23218; H04N 5/23222; H04N 5/23245; H04N 5/232935

(57) ABSTRACT

An image correction terminal provided starts a camera, to enter a default shooting mode; the terminal previews a photographed object, to obtain a preview image; the terminal determines, based on the preview image, whether the photographed object is of a document type; and the terminal corrects a photographed object image when the photographed object is of the document type, where the photographed object image is an image obtained after the photographed object is photographed. As a result, the terminal can effectively detect a scene type, and avoid system power consumption caused due to frequent detection of a type of the photographed object.

### CROSS-REFERENCE TO RELATED APPLICATIONS

This application is a national stage of international Application No. PCT/CN2017/081146, filed on Apr. 19, 2017, which claims priority to Chinese Patent Application No. 201710222059.9, filed on Apr. 6, 2017. Both of the aforementioned applications are hereby incorporated by reference in their entireties.

### TECHNICAL FIELD Aspects of this application relate to the field of image processing technologies, and in particular, to a document image correction method and an apparatus.

### BACKGROUND

In recent years, with rapid popularization of intelligent terminals such as mobile phones, shooting performance of the mobile phones has been continuously improved, and various shooting modes are preset in the mobile phones, meeting requirements of users in different types of scenes, and facilitating document image data obtaining.

However, for recognition in the existing shooting modes, the mobile phones need to frequently detect and calculate in background, increasing system power consumption when the mobile phones photograph document images. Therefore, a method that can properly control system power consumption and effectively detect a scene type is required.

### SUMMARY

Aspects of this application describe a document image correction method and an apparatus, to resolve the foregoing problem in the prior art.

According to a first aspect, a document image correction method is provided. The method includes: starting, by a terminal, a camera, to enter a default shooting mode; previewing, by the terminal, a photographed object, obtain a preview image; determining, by the terminal based on the preview image, whether the photographed object is of a document type; and correcting, by the terminal, a photographed object image when the photographed object is of the document type, where the photographed object image is an image obtained after the photographed object is photographed. By obtaining the preview image of the photographed object, the terminal can determine a type of the photographed object, thereby correcting the photographed object image of the document type in a timely manner, and improving efficiency in photographing and correcting the photographed object of the document type.

In a possible design of the first aspect, the method further includes: maintaining, by the terminal, the default shooting mode when the photographed object is not of the document type. By maintaining the default shooting mode, the terminal can avoid frequent detection of the type of the photographed object and control system power consumption.

In a possible design of the first aspect, the correcting, by the terminal, a photographed object image when the photographed object is of the document type includes: correcting, by the terminal, the photographed object image when the photographed object is of the document type and the terminal determines that a current scene type is a preset scene type. By comprehensively determining the type of the photographed object and the current scene type, the terminal can more accurately determine the type of the photographed object, thereby correcting the photographed object image of the document type in a timely manner and improving photographing efficiency of a document image.

In a possible design of the first aspect, that the terminal determines that a current scene type is a preset scene type includes: determining, by the terminal, a confidence level of the current scene type; and determining, by the terminal, that the current scene type is the preset scene type, when the confidence level is greater than or equal to a predetermined threshold. By calculating the confidence level of the scene type, the terminal can increase detection accuracy of the scene type.

In a possible design of the first aspect, the method further includes: obtaining, by the terminal, the current scene type, where the scene type includes at least one of the following information: position information, motion state information, environmental sound information, or user schedule information. By using the foregoing information, the terminal can determine the current scene type from different determining dimensions.

In a possible design of the first aspect, the obtaining, by the terminal, the current scene type includes: periodically obtaining, by the terminal, the current scene type. By periodically obtaining the current scene type, the terminal can avoid system power consumption caused by continuous turning on of a sensor while collecting various types of scene information.

In a possible design of the first aspect, before the correcting, by the terminal, a photographed object image, the method further includes: prompting, by the terminal, a user to choose whether to correct the photographed object image. By prompting the user to select an operation, the terminal can increase interactions with the user, thereby improving accuracy of a document image correction operation and better meeting a user requirement.

In a possible design of the first aspect, the preview image is a preview image obtained after the photographed object is focused. By capturing the preview image obtained in the focusing process, the terminal can obtain a clear preview image, thereby improving accuracy of detecting the type of the photographed object.

In a possible design of the first aspect, the document type includes: a document, a picture, a contact card, credentials, a book, a slideshow, a whiteboard, a guideboard, or an advertising sign type. In this way, the terminal can determine a type of a photographed object that needs to be corrected during photographing.

In a possible design of the first aspect, the preset scene type includes a conference room, a classroom, or a library scene type. In this way, the terminal can determine a type of a scene in which a photographed object that needs to be corrected is located.

According to a second aspect, a terminal is provided. The terminal includes: a starting module, configured to start a camera, to enter a default shooting mode; a preview module, configured to preview a photographed object, to obtain a preview image; a determining module, configured to determine, based on the preview image, whether the photographed object is of a document type; and a correction module, configured to correct a photographed object image when the photographed object is of the document type, where the photographed object image is an image obtained after the photographed object is photographed. By obtaining the preview image of the photographed object, the terminal can determine a type of the photographed object, thereby correcting the photographed object image of the document type in a timely manner, and improving efficiency in photographing and correcting the photographed object of the document type.

In a possible design of the second aspect, the terminal further includes: a maintaining module, configured to maintain the default shooting mode when the photographed object is not of the document type. By maintaining the default shooting mode, the terminal can avoid frequent detection of the type of the photographed object and control system power consumption.

In a possible design of the second aspect, the correction module is configured to correct the photographed object image when the photographed object is of the document type and the terminal determines that a current scene type is a preset scene type. By comprehensively determining the type of the photographed object and the current scene type, the terminal can more accurately determine the type of the photographed object, thereby correcting the photographed object image of the document type in a timely manner and improving photographing efficiency of a document image.

In a possible design of the second aspect, the correction module includes: a calculation unit, configured to determine a confidence level of the current scene type; and a determining unit, configured to determine that the current scene type is the preset scene type, when the confidence level is greater than or equal to a predetermined threshold. By calculating the confidence level of the scene type, the terminal can increase detection accuracy of the scene type.

In a possible design of the second aspect, the terminal further includes: an obtaining module, configured to obtain the current scene type, where the scene type includes at least one of the following information: position information, motion state information, environmental sound information, or user schedule information. By using the foregoing information, the terminal can determine the current scene type from different determining dimensions.

In a possible design of the second aspect, the obtaining module is configured to periodically obtain the current scene type. By periodically obtaining the current scene type, the terminal can avoid system power consumption caused by continuous turning on of a sensor while collecting various types of scene information.

In a possible design of the second aspect, the terminal further includes a prompting module, configured to: before the terminal corrects the photographed object image, prompt a user to choose whether to correct the photographed object image. By prompting the user to select an operation, the terminal can increase interactions with the user, thereby improving accuracy of a document image correction operation and better meeting a user requirement.

In a possible design of the second aspect, the preview image is a preview image obtained after the photographed object is focused. By capturing the preview image obtained in the focusing process, the terminal can obtain a clear preview image, thereby improving accuracy of detecting the type of the photographed object.

In a possible design of the second aspect, the document type includes: a document, a picture, a contact card, credentials, a book, a slideshow, a whiteboard, a guideboard, or an advertising sign type. In this way, the terminal can determine a type of a photographed object that needs to be corrected during photographing.

In a possible design of the second aspect, the preset scene type includes a conference room, a classroom, or a library scene type. In this way, the terminal can determine a type of a scene in which a photographed object that needs to be corrected is located.

According to a third aspect, a terminal is provided. The terminal includes a camera, a processor, and a memory, where the processor is configured to: start the camera, to enter a default shooting mode; preview a photographed object, to obtain a preview image; determine, based on the preview image, whether the photographed object is of a document type; and correct a photographed object image when the photographed object is of the document type, where the photographed object image is an image obtained after the photographed object is photographed. By obtaining the preview image of the photographed object, the terminal can determine a type of the photographed object, thereby correcting the photographed object image of the document type in a timely manner, and improving efficiency in photographing and correcting the photographed object of the document type.

In a possible design of the third aspect, the processor is further configured to maintain the default shooting mode when the photographed object is not of the document type. By maintaining the default shooting mode, the terminal can avoid frequent detection of the type of the photographed object and control system power consumption.

In a possible design of the third aspect, the processor is configured to correct the photographed object image when the photographed object is of the document type and the terminal determines that a current scene type is a preset scene type. By comprehensively determining the type of the photographed object and the current scene type, the terminal can more accurately determine the type of the photographed object, thereby correcting the photographed object image of the document type in a timely manner and improving photographing efficiency of a document image.

In a possible design of the third aspect, the processor is configured to: determine a confidence level of the current scene type; and determine that the current scene type is the preset scene type, when the confidence level is greater than or equal to a predetermined threshold. By calculating the confidence level of the scene type, the terminal can increase detection accuracy of the scene type.

In a possible design of the third aspect, a sensor is configured to obtain the current scene type, where the scene type includes at least one of the following information: position information, motion state information, environmental sound information, or user schedule information. By using the foregoing information, the terminal can determine the current scene type from different determining dimensions.

In a possible design of the third aspect, the sensor is configured to periodically obtain the current scene type. By periodically obtaining the current scene type, the terminal can avoid system power consumption caused by continuous turning on of a sensor while collecting various types of scene information.

In a possible design of the third aspect, the processor is configured to: before the terminal corrects the photographed object image, prompt a user to choose whether to correct the photographed object image. By prompting the user to select an operation, the terminal can increase interactions with the user, thereby improving accuracy of a document image correction operation and better meeting a user requirement.

In a possible design of the third aspect, the preview image is a preview image obtained after the photographed object is focused. By capturing the preview image obtained in the focusing process, the terminal can obtain a clear preview image, thereby improving accuracy of detecting the type of the photographed object.

In a possible design of the third aspect, the document type includes: a document, a picture, a contact card, credentials, a book, a slideshow, a whiteboard, a guideboard, or an advertising sign type. In this way, the terminal can determine a type of a photographed object that needs to be corrected during photographing.

In a possible design of the third aspect, the preset scene type includes a conference room, a classroom, or a library scene type. In this way, the terminal can determine a type of a scene in which a photographed object that needs to be corrected is located.

According to a fourth aspect, a computer program product including an instruction is provided. When the instruction is run on a computer, the computer is enabled to perform the method according to the first aspect.

According to a fifth aspect, a computer-readable storage medium is provided. The computer-readable storage medium stores an instruction. When the instruction is run on a computer, the computer is enabled to perform the method according to the first aspect.

According to the technical solutions provided in embodiments of the present invention, the terminal obtains the preview image of the photographed object when starting the camera, recognizes the preview image, and determines, based on a recognition result, whether the photographed object is of the document type, so that the scene type can be effectively detected, thereby avoiding system power consumption caused due to frequent detection of the type of the photographed object.

### BRIEF DESCRIPTION OF DRAWINGS

To describe the technical solutions in the embodiments of the present invention more clearly, the following briefly introduces the accompanying drawings required for describing the embodiments. Apparently, the accompanying drawings in the following description show merely some but not all of embodiments of the present invention. A person of ordinary skill in the art may further derive other implementations based on these accompanying drawings without creative effects. All these embodiments or implementations fall within the protection scope of this application.

FIG. 1 is a schematic structural diagram of a first terminal according to an embodiment of the present invention;

FIGS. 2A and 2B are schematic diagrams of a document image correction scene according to an embodiment of the present invention;

FIG. 3 is a flowchart of a first document image correction method according to an embodiment of the present invention;

FIG. 4 is a flowchart of a second document image correction method according to an embodiment of the present invention;

FIG. 5 is a flowchart of a third document image correction method according to an embodiment of the present invention;

FIG. 6 is a flowchart of a fourth document image correction method according to an embodiment of the present invention;

FIG. 7 is a schematic structural diagram of a second terminal according to an embodiment of the present invention; and

FIG. 8 is a schematic structural diagram of a third terminal according to an embodiment of the present invention.

### DESCRIPTION OF EMBODIMENTS

The following describes the embodiments of the present invention with reference to the accompanying drawings in the embodiments of the present invention.

An image correction method and an apparatus of the embodiments of the present invention may be applied to any terminal having a screen and a plurality of application programs. The apparatus may be hardware that has a processing capability and that is mounted in the terminal, software, or a combination of software and hardware. The terminal may be a terminal such as a mobile phone or a cell phone, a tablet personal computer (Tablet Personal Computer, TPC), a laptop computer (Laptop Computer), a digital camera, a digital video camera, a projection device, a wearable device (Wearable Device), a personal digital assistant (Personal Digital Assistant, PDA), an e-book reader (e-Book Reader), a virtual reality intelligent device, a digital broadcast terminal, a message transceiver device, a game console, a medical device, a fitness device, or a scanner. The terminal may establish communication with a network by using a 2G, 3G, 4G, 5G, or wireless local area network (Wireless Local Access Network. WLAN).

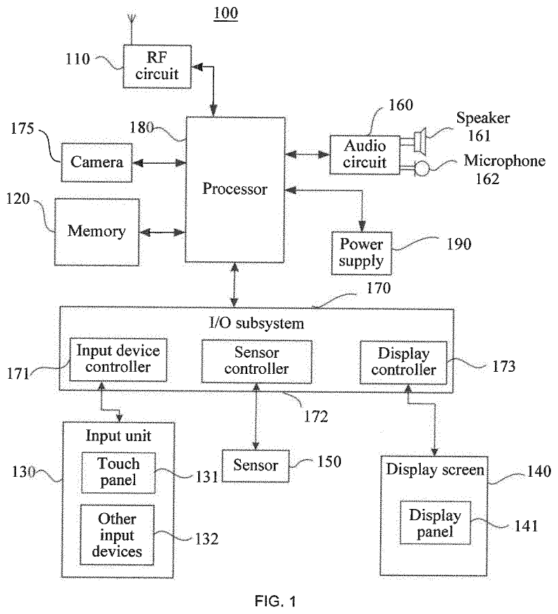

The embodiments of the present invention are described by using an example in which the terminal is a mobile phone. FIG. 1 is a block diagram of a partial structure of a mobile phone 100 related to the embodiments of the present invention. As shown in FIG. 1, the mobile phone 100 includes components such as a radio frequency (Radio Frequency, RF) circuit 110, a memory 120, an input unit 130, a display screen 140, a sensor 150, an audio circuit 160, an input/output (Input/Output, I/O) subsystem 170, a camera 175, a processor 180, and a power supply 190. A person skilled in the art may understand that, the structure of the terminal shown in FIG. 1 is merely used as an example of an implementation and does not constitute any limitation on the terminal. The terminal may include more or fewer components than those shown in the figure, or some components may be combined, or a different component deployment may be used.

The RF circuit 110 may be configured to receive and send signals during an information receiving and sending process or a call process. Particularly, the RF circuit 110 receives downlink information from a base station, then delivers the downlink information to the processor 180 for processing, and sends related uplink data to the base station. Usually, the RF circuit includes, but is not limited to, an antenna, at least one amplifier, a transceiver, a coupler, a low noise amplifier (Low Noise Amplifier, LNA), and a duplexer. In addition, the RF circuit 110 may also communicate with a network and another device through wireless communication. The wireless communication may use any communication standard or protocol, including but not limited to: Global System for Mobile Communications (Global System of Mobile communication, GSM), General Packet Radio Service (General Packet Radio Service, GPRS), Code Division Multiple Access (Code Division Multiple Access, CDMA), Wideband Code Division Multiple Access (Wideband Code Division Multiple Access, WCDMA), Long Term Evolution (Long Term Evolution, LTE), email, and a short message service (Short Messaging Service, SMS).

The memory 120 may be configured to store a software program and module. The processor 180 runs the software program and module stored in the memory 120, to implement various functional applications and data processing of the mobile phone 100. The memory 120 may include a program storage area and a data storage area, where the program storage area may store an operating system, an application program required by at least one function (such as a sound playback function and an image display function), and the like; and the data storage area may store data (such as audio data, video data, and a telephone directory) created based on use of the mobile phone 100, and the like. In addition, the memory 120 may include a volatile memory, for example, a nonvolatile random access memory (Nonvolatile Random Access Memory, NVRAM), a phase change random access memory (Phase Change RAM, PRAM), or a magnetoresistive random access memory (Magetoresistive RAM, MRAM), and may further include a nonvolatile memory, for example, at least one magnetic storage device, an electrically erasable programmable read-only memory (Electrically Erasable Programmable Read-Only Memory, EEPROM), or a flash memory, for example, a NOR flash memory (NOR flash memory) or an NAND flash memory (NAND flash memory), or a semiconductor device, for example, a solid state disk (Solid State Disk, SSD).

The input unit 130 may be configured to receive input digit or character information, and generate a key signal input related to a user setting and function control of the mobile phone 100. Specifically, the input unit 130 may include a touch panel 131 and other input devices 132. The touch panel 131, also referred to as a touchscreen, may collect a touch operation of a user on or close to the touch panel (such as an operation of a user on or close to the touch panel 131 by using any suitable object or accessory such as a finger or a stylus), and drive a corresponding connection apparatus based on a preset program. Optionally, the touch panel 131 may include two parts: a touch detection apparatus and a touch controller. The touch detection apparatus detects a touch location of the user, detects a signal generated by the touch operation, and transfers the signal to the touch controller. The touch controller receives touch information from the touch detection apparatus, converts the touch information into touch point coordinates, and then sends the touch point coordinates to the processor 180. Moreover, the touch controller can receive and execute a command sent by the processor 180. In addition, the touch panel 131 may be a resistive, capacitive, infrared, or surface sound wave type touch panel. In addition to the touch panel 131, the input unit 130 may further include the other input devices 132. Specifically, the other input devices 132 may include, but is not limited to, one or more of a physical keyboard, a functional key (such as a volume control key or a switch key), a track ball, a mouse, and a joystick.

The display screen 140 may be configured to display information entered by the user or information provided for the user, and various interfaces of the mobile phone 100. The display screen 140 may include a display panel 141. Optionally, the display panel 141 may be configured in a form of a liquid crystal display (Liquid Crystal Display, LCD), a thin film transistor LCD (Thin Film Transistor LCD, TFT-LCD) light-emitting diode (Light Emitting Diode, LED), an organic light-emitting diode (Organic Light-Emitting Diode, OLED), or the like. Further, the touch panel 131 may cover the display panel 141. After detecting a touch operation on or close to the touch panel 131, the touch panel 131 transfers the touch operation to the processor 180, to determine a type of a touch event. Then, the processor 180 provides a corresponding visual output on the display panel 141 based on the type of the touch event. Although in FIG. 1, the touch panel 131 and the display panel 141 are used as two separate components to implement input and output functions of the mobile phone 100, in some embodiments, the touch panel 131 and the display panel 141 may be integrated to implement the input and output functions of the mobile phone 100. The display screen 140 may be configured to display content, where the content includes a user interface, such as a boot interface of the terminal, or a user interface of an application program. In addition to the user interface, the content may further include information and data. The display screen 140 may be a built-in screen of the terminal or another external display device.

The sensor 150 includes at least one optical sensor, a motion sensor, a position sensor, and other sensors. Specifically, the optical sensor may include an ambient light sensor and a proximity sensor. The ambient light sensor may obtain brightness of ambient light. The proximity sensor may switch off the display panel 141 and/or backlight when the mobile phone 100 is moved to the ear. The motion sensor may include an acceleration sensor that may detect magnitude of accelerations in various directions (which are usually triaxial), may detect magnitude and a direction of gravity when the mobile phone is static, and may be used for an application that identifies a mobile phone gesture (for example, switching between a horizontal screen and a vertical screen, a related game, and magnetometer gesture calibration), a function related to vibration identification (for example, a pedometer and a knock), and the like. The position sensor may be configured to obtain geographical location coordinates of the terminal. The geographical location coordinates may be obtained by using the Global Positioning System (Global Positioning System, GPS), the COMPASS System (COMPASS System), the GLONASS System (GLONASS System), the GALILEO System (GALILEO System), or the like. The position sensor may be further located by using a base station of a mobile operation network and a local area network such as Wi-Fi or Bluetooth, or the foregoing positioning manners are combined, thereby obtaining more accurate position information of the mobile phone. Another sensor, such as a gyroscope, a barometer, a hygrometer, a thermometer, or an infrared sensor that may be further configured in the mobile phone 100 is not described in detail herein.

The audio circuit 160, a speaker 161, and a microphone 162 (also referred to as a microphone) may provide audio interfaces between the user and the mobile phone 100. The audio circuit 160 may convert received audio data into an electrical signal and transmit the electrical signal to the speaker 161. The speaker 161 converts the electrical signal into a sound signal for output. On the other hand, the microphone 162 converts a collected sound signal into an electrical signal. The audio circuit 160 receives the electrical signal, converts the electrical signal into audio data, and outputs the audio data to the processor 180 for processing. Then, the processor 180 sends the audio data to, for example, another terminal by using the RF circuit 110, or outputs the audio data to the memory 120 for further processing.

The I/O subsystem 170 may be configured to input or output various information or data of the system. The subsystem 170 includes an input device controller 171, a sensor controller 172, and a display controller 173. The I/O subsystem 170 receives, by using the foregoing controller, various data sent by the input unit 130, the sensor 150, and the display screen 140, and controls the foregoing components by sending control instructions.

The camera 175 may be configured to obtain a photographed object image. The image is a bitmap including pixel lattices. The camera 175 may include one or more cameras. The camera may include one or more parameters. These parameters include a lens focal length, a shutter speed, an ISO sensitivity, resolution, and the like. When there are at least two cameras, parameters of these cameras may be the same or different.

The foregoing parameters are manually set by the user or automatically set by the mobile phone 100, so that the camera 175 can obtain the photographed object image. The image is a bitmap including pixel lattices.

The processor 180 is a control center of the mobile phone 100, and is connected to all parts of the mobile phone by using various interfaces and lines. By running or executing the software program and/or module stored in the memory 120, and invoking data stored in the memory 120, the processor 100 performs various functions and data processing of the mobile phone 1000, thereby performing overall monitoring on the mobile phone. The processor 180 may be a central processing unit (Central Processing Unit, CPU), a general purpose processor, a digital signal processor (Digital Signal Processor, DSP), an application-specific integrated circuit (Application Specific Integrated Circuit, ASIC), a field programmable gate array (Field Programmable Gate Array, FPGA), or another programmable logic device, transistor logic device, hardware component, or any combination thereof. The processor 180 can implement or perform various examples of logic blocks, modules, and circuits described with reference to content disclosed in this application. Alternatively, the processor 180 may be a combination implementing a calculation function, for example, a combination including one or more microprocessors, or a combination of a DSP and a microprocessor. Optionally, the processor 180 may include one or more processor units. Optionally, the processor 180 may further integrate an application processor and a modem. The application processor mainly processes an operating system, a user interface, an application program, and the like. The modem mainly processes wireless communication. It may be understood that the foregoing modem processor may alternatively not be integrated into the processor 180.

The application program includes any application installed in the mobile phone 100, and includes but is not limited to a browser, an email, an instant messaging service, text processing, keyboard virtualization, a window widget (Widget), encryption, digital rights management, voice recognition, voice replication, positioning (for example, a function provided by the GPS), music play, and the like.

The mobile phone 100 further includes the power supply 190 (such as a battery) for supplying power to the components. Optionally, the power supply may be logically connected to the processor 180 by using a power management system, thereby implementing functions such as charging, discharging and power consumption management by using the power management system.

It should be noted that although not shown, the mobile phone 100 may further include a short-range wireless transmission device such as a Wi-Fi module or Bluetooth. Details are not described herein again.

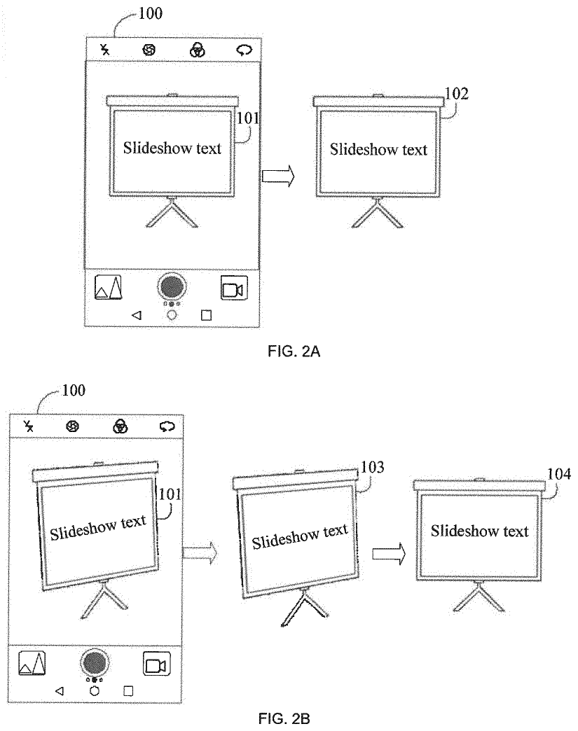

FIGS. 2A and 2B shows an image obtaining scenario according to an embodiment of the present invention. In FIG. 2A, the mobile phone 100 obtains a photographed object image 102 from a front side of the photographed object 101 by using the camera. The photographed object 101 includes photographed objects of various document types. The document type includes a document, a picture, a contact card, credentials, a book, a slideshow, a whiteboard, a guideboard, an advertising sign, or the like. When the mobile phone 100 is located on the front side of the photographed object 101, an optical axis of the camera may be perpendicular to a plane in which the photographed object 101 is located, so that the photographed object image 102 and an original shape and proportion of the photographed object 101 are consistent with each other. In this case, the photographed object image 102 does not need to be corrected.

In FIG. 2B, the mobile phone 100 obtains a photographed object image 103 from a side of the photographed object 101 by using the camera. When the mobile phone 100 is located on the side of the photographed object 101, the optical axis of the camera may be inclined at an angle to the plane in which the photographed object 101 is located. Due to impact of a perspective effect, the photographed object image 103 produces perspective distortion. This adversely affects reading, recognition, analysis, or processing of text or a graphic in the image. Therefore, the photographed object image 103 should be corrected. To correct an image, a current image may be mapped from one plane to another in a geometric projection manner by using a known perspective transformation method (also referred to as projection mapping). Optionally, a region of the photographed object 101 in the image may be further cropped after the correction is completed, to obtain a photographed object image 104 substantially consistent with the original photographed object.

### Embodiment 1

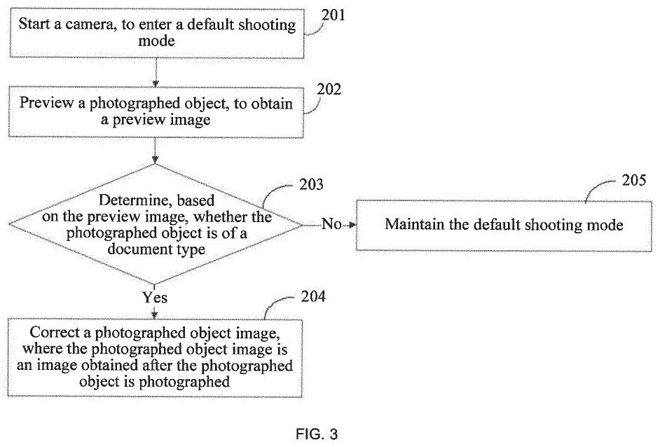

The following describes, with reference to FIG. 3 a first document image correction method provided in this embodiment of the present invention. FIG. 3 is a flowchart of the first document image correction method. The method is performed by a terminal. The method includes the following steps.

Step 201. The terminal starts a camera, to enter a default shooting mode.

Step 202. The terminal previews a photographed object, to obtain a preview image.

Step 203. The terminal determines, based on the preview image, whether the photographed object is of a document type.

Step 204. The terminal corrects a photographed object image when the photographed object is of the document type, where the photographed object image is an image obtained after the photographed object is photographed.

Step 205. The terminal maintains the default shooting mode when the photographed object is not of the document type.

In step 201, the terminal may start the camera in a plurality of manners. For example, a user clicks a camera application program icon, or a user clicks a camera shortcut in another application program, for example, clicks to scan a two-dimensional code in a browser application program, or clicks to take a photograph in an instant messaging application program.

The camera may be the camera 175 described above. Parameters of the camera may include an initialization parameter combination. The initialization parameter combination may be set in the terminal at delivery. When the terminal starts the camera, the terminal may set the parameters of the camera based on the initialization parameter combination. When the parameters of the camera are set, the terminal may enter the default shooting mode, and display a preview interface of the photographed object.

Alternatively, the parameters of the camera may include a plurality of different parameter combinations. Different parameter combinations are set for the camera, so that the camera can perform photographing in a plurality of types of shooting scenes. To facilitate invoking or quick setting of the parameters of the camera, one or at least two shooting modes may be set for the terminal. In other words, a camera application program or another related application program of the terminal may include one or at least two shooting modes, and each shooting mode has one parameter combination. The terminal can quickly set the parameters of the camera by entering different shooting modes. Using the camera application program as an example, there may be a plurality of shooting modes: a normal shooting mode, a night shooting mode, a facial beautification shooting mode, and a panoramic shooting mode. The normal shooting mode may correspond to the initialization parameter, and the normal shooting mode can meet most daily shooting. The night shooting mode may have a group of parameters suitable for photographing when light is insufficient, for example, a higher ISO sensitivity, or a larger f-number, so that a clear image can be photographed when light is insufficient or during night. The facial beautification shooting mode can activate a facial beautification function, so that a beautified portrait image can be obtained. The panoramic shooting mode can activate an image splicing function, so that a plurality of images can be automatically stitched.

The default shooting mode may be a shooting mode that is first entered after the camera is started. In other words, when the parameters of the camera are set, the terminal enters the default shooting mode. The default shooting mode may be the normal mode; or may be a shooting mode of the terminal when the terminal last exits the camera application program. For example, if the terminal is in the facial beautification shooting mode when the terminal last exits the camera application program, the terminal enters the facial beautification shooting mode when starting the camera. Alternatively, the default shooting mode may be a shooting mode determined by the terminal based on a use habit of the user. For example, the terminal collects statistics about frequency for using various shooting modes by the user, and uses a shooting mode with highest frequency as the default shooting mode.

The preview interface may display a dynamic preview image of the photographed object, or may display other preview content, such as shooting information or a function key. The dynamic preview image may be a real-time image formed by the photographed object on an optical sensor of the camera. The optical sensor may be any optical sensor that can obtain an image, for example, a charge coupled device (Charge Coupled Device, CCD) sensor or a complementary metal-oxide-semiconductor (Complementary Metal Oxide Semiconductor, CMOS). The shooting information may include parameter values of the camera. The function key may be used to input a user operation instruction, for example, a capture key, a video/photo switching button, an album key, a camera flash key, a color/tone key, and a shooting mode selection key. It may be understood that the terminal can display the preview interface of the photographed object in any shooting mode.

In step 202, the terminal previews the photographed object, and obtains the preview image from a dynamic preview image. The preview image may be obtained in default shooting mode, or may be obtained in another shooting mode.

In an example, the terminal may capture a frame of the dynamic preview image in the default shooting mode. The frame is a unit constituting the dynamic preview image. One frame is a static preview image, and a plurality of consecutive frames form a dynamic preview image.

Optionally, the terminal may capture a first frame of the dynamic preview image. In other words, when entering the default shooting mode, the terminal captures an earliest obtained preview image. By dynamically capturing the first frame of the dynamic preview image, the terminal can minimize a time for obtaining the preview image, and determine, as early as possible, whether the photographed object is of the document type, thereby shortening a time required by an entire method.

Optionally, when entering the default shooting mode, the terminal may control the camera to focus the photographed object, and capture a preview image obtained during focusing. By focusing the photographed object and capturing the preview image obtained through focusing, the terminal can obtain a clear preview image, thereby obtaining a preview image with higher quality. This is beneficial for processing in a subsequent step, such as quadrangle detection or recognition, and further improves accuracy of detecting the type of the photographed object.

Optionally, the terminal may capture a frame of the dynamic preview image at a preset moment after obtaining the dynamic preview image. In other words, the terminal captures a frame of a preset moment after the preset moment elapses from when the dynamic preview image can be obtained. The preset moment may be determined based on an actual need, for example, 500 ms (millisecond), 1 s, or 2 s. This is not limited in this application. The terminal may have not entered a proper shooting position when starting the camera, for example, the terminal has not aligned the photographed object. Therefore, by setting the preset moment, the terminal can enter a proper shooting position, to obtain a preview image with higher quality. This is beneficial for processing in a subsequent step. It may be understood that the preset moment may be replaced with a preset frame. Because the dynamic preview image usually has a fixed quantity of frames per unit time, for example, 24 frames/s, 30 frames/s, or 60 frames/s the preset moment may be replaced with the preset frame. The terminal captures the preset frame from when the dynamic preview image can be obtained, for example, captures a twelfth frame, a fifteenth frame, a twenty-fourth frame, or a thirtieth frame, thereby obtaining a corresponding preview image. By setting a quantity of preset frames, the terminal can enter the proper shooting position, thereby obtaining a preview image with higher quality. This is beneficial for processing in a subsequent step.

Optionally, the terminal may capture a frame of the dynamic preview image when detecting a static state or a subtle motion. The terminal may detect the static state or the subtle motion based on an image analysis method. For example, a frame difference method is used to calculate a difference between two consecutive frames of images. When the difference is less than a predetermined threshold, it is considered as a static state or that the motion is subtle. The terminal may alternatively be based on a motion sensor method. For example, an acceleration sensor is used to obtain accelerations of three axes of a spatial three-dimensional coordinate system, a geometric average value of the accelerations of the three axes is calculated, and a difference between the geometric average value and the gravity acceleration G is determined. When an absolute value of the difference is less than a predetermined threshold, it is considered that the terminal is static or moves subtly. It can be understood that the predetermined threshold in the foregoing example may be determined based on an actual need. This is not limited in this application. Usually, when the terminal aligns the photographed object, the user does not move the terminal any more. Therefore, the terminal is in the static state or moves subtly. Capturing a frame of the dynamic preview image in the state can both obtain a clear preview image and ensure that the terminal enters a proper shooting position, thereby obtaining a preview image with higher quality. This is beneficial for processing in a subsequent step.

In some other examples, the terminal may obtain the preview image of the photographed object in the foregoing various manners when switching from the default shooting mode to another shooting mode.

In step 203, the determining, by the terminal based on the preview image, whether the photographed object is of a document type includes: determining, by the terminal, whether the preview image includes a quadrangle. If the preview image includes a quadrangle, the terminal classifies and recognizes a preview image of a region enclosed by the quadrangle. When the preview image of the region enclosed by the quadrangle is of the document type, the terminal determines that the photographed object is of the document type; otherwise, the terminal determines that the photographed object is not of the document type.

The terminal performs quadrangle detection on the preview image to determine whether the preview image includes a quadrangle.

In an example, the method for quadrangle detection includes: first, the terminal preprocesses the preview image, including a process of performing Gaussian distribution sampling, color-to-grayscale, median filtering, and the like on an image. The foregoing preprocessing process is a known method in the art, and is not further described herein. Then, the terminal performs line segment detection (Line segment Detector, LSD) on the preprocessed preview image, to find all line segments included in the image. Subsequently, a shorter line segment is removed based on a specified length threshold, and remaining line segments are classified. These line segments are classified into horizontal line segments and vertical line segments. For example, the length threshold is set to 5% of a length of a currently longest line segment, and a line segment with a length less than the length threshold is removed. In addition, a line segment with an excessively large angle of inclination is removed based on a specified angle threshold. For example, the angle threshold is set to ±30°. A line segment with an angle of inclination exceeding the angle threshold is removed. An angle between a horizontal line segment and a horizontal axis is made between −30° and +30°. An angle between a vertical line segment and a vertical axis is made between −30° and +30°. Quadrangle forming is performed by using lines to which the horizontal line segments and the vertical line segments belong, and a plurality of quadrangles can be obtained.

The plurality of quadrangles are filtered, where a quadrangle with an excessively large or small area is removed, a quadrangle with an excessively large or small opposite side distance is removed, a quadrangle located at an edge of a screen is removed, and N quadrangles are obtained, where N is a positive integer. The removing a quadrangle with an excessively large or small area includes setting an area threshold. For example, the area threshold is 10% and 80% of an entire area of the preview image, and a quadrangle with an area less than 10% of and greater than 80% of the entire area of the preview image is removed. The removing a quadrangle with an excessively large or small opposite side distance includes setting a proportion threshold. For example the proportion threshold is 0.1 or 10, and a quadrangle with a ratio of a group of opposite side distances to the other group of opposite side distances less than 0.1 and greater than 10 is removed. The removing a quadrangle located at an edge of a screen includes setting a distance threshold. For example, the distance threshold is 2% of a length or a width of the preview image, and a quadrangle with a distance to the edge of the screen less than the foregoing distance threshold is removed.

Finally, a ratio of an LSD line segment pixel quantity to a quadrangle perimeter is calculated for each of the N quadrangles, and a quadrangle with a largest ratio is used as a finally detected quadrangle.

In some other examples, the quadrangle detection may alternatively be performed by using another known method. Details are not described herein.

The terminal recognizes a preview image of a region enclosed by the finally detected quadrangle.

In an example, a process of the recognition includes: first, the terminal extends the detected quadrangle. Because there may be an error in the quadrangle detection, an edge of the detected quadrangle is caused to be located inside the photographed object. For example, a photographed object with an outer bezel, such as a screen, a display, a television, or another device, the detected quadrangle may be located inside an outer bezel of each of these devices and the outer bezel is not included. Because the outer bezel has obvious features such as black or white, adding the outer bezel to the quadrilateral region helps improve accuracy of image recognition or classification. An extended quadrilateral region may be a region formed by outwardly extending each side of the quadrangle by a particular distance. For example, the distance may be 50 pixels, or may be 5% of a length or a width of a preview image of the photographed object.

Then, the terminal performs target recognition on an image of the extended quadrilateral region. The target recognition may be based on an existing machine learning method. For example, a large-scale image data set with a tag is used as a training set, to obtain an image recognition or classification model. Then, an image in the extended quadrilateral region is input into the recognition or classification model, to obtain the type of the photographed object. In the image recognition or classification model, an image may be classified into various document types and another type. The document type may be a type of a photographed object that needs to be corrected during photographing, for example, a slideshow, a whiteboard, a document, a book, credentials, a billboard, or a guideboard. The another type may be a type of a photographed object that does not need to be corrected during photographing, for example, a landscape or a portrait. The another type may alternatively be a type of a photographed object other than the foregoing document type. For example, in the image recognition or classification model, an image is classified into a slideshow, a whiteboard, a document, a book, credentials, a billboard, a guideboard, or another type. When the image of the extended quadrilateral region is a slideshow image, the terminal inputs the image into the image recognition or classification model, and the image may be recognized as of the slideshow type. Because the slideshow type is one of document types, the terminal may determine that the photographed object in the preview image is of the document type. When the image of the extended quadrilateral region is a landscape image, the terminal inputs the image into the image recognition or classification model, and the image may be recognized as of the another type. Because the another type is not the document type, the terminal may determine that the photographed object in the preview image is not of the document type.

Further, optionally, the document type may be further classified into a document type regarding a plurality of corrections and a document type regarding a single correction. The document type regarding a plurality of corrections may be a type of a photographed object having a plurality of pages, for example, a slideshow, a document, or a book. The document type regarding a single correction may be a type of a photographed object having a single page, for example, a whiteboard, credentials, a billboard, or a guideboard.

In step 204, the terminal corrects the photographed object image when the photographed object is of the document type, where the photographed object image is an image obtained after the photographed object is photographed. To correct the photographed object image, the terminal may perform the quadrangle detection described in step 203 on the photographed object image, and correct the photographed object image in a region enclosed by the quadrangle, to correct the photographed object image in the region to a rectangle. The method for correcting the image may be a perspective transformation method (also referred to as projection mapping) mentioned above, or may be another known method.

Optionally, the terminal may extend the detected quadrangle, and correct the photographed object image in the region enclosed by the extended quadrangle. The quadrangle may be extended by using the method described in step 203, and details are not described herein again.

Optionally, before correcting the photographed object image, the terminal may prompt a user to choose whether to correct the photographed object image, and perform a corresponding operation based on a selection by the user. For example, the terminal may display a dialog box on a screen, to prompt the user to choose whether to correct a document. If the user selects yes, the terminal corrects the photographed object image; otherwise, the terminal does not correct the photographed object image. Further, when the user selects no, the terminal may further prompt the user to choose whether to perform a single correction on the photographed object image. If the user selects yes, the terminal may maintain the default shooting mode, and perform a single correction on a to-be-photographed image of a photographed object; otherwise, the terminal maintains the default shooting mode, and does not correct the photographed object image. In this way, interactions between the terminal and the user can be increased, thereby better meeting a user requirement.

Optionally, after completing the correction, the terminal may display a message on the screen, to prompt the user that the image has been corrected. The message may be presented in various manners, for example, by using a notification bar or a message box.

To facilitate correction of a photographed object image of the document type, a document correction function may be set for the terminal. When the document correction function is enabled, the terminal may perform the quadrangle detection on the dynamic preview image of the photographed object. The terminal corrects the photographed object image after photographing the photographed object.

Optionally, after the document correction function is enabled, the terminal may superimpose and display, based on a result of the quadrangle detection, the detected quadrangle onto the dynamic preview image of the photographed object. The terminal may highlight the detected quadrangle in various manners, for example, boldly display sides of the quadrangle, or display sides of the quadrangle with a conspicuous color, such as white, red, or green, or the foregoing two manners maybe combined. Optionally, the terminal may display the sides of the quadrangle with a color different from a color of a face prompt box, so that the user can easily distinguish between different types of prompt boxes.

Optionally, a document shooting mode (document mode for short) may be set for the terminal. When the terminal enters the document mode, the document correction function is enabled. The terminal may further set, for the camera, a group of parameters suitable for photographing a document image. It can be understood that for the document type regarding a plurality of corrections, the terminal can easily photograph and correct the photographed object for a plurality of times in the document correction mode.

Optionally, when the photographed object is of the document type regarding a single correction, the terminal may maintain the default shooting mode, and enable the document correction function at the same time. After photographing the photographed object, the terminal performs a single correction on the photographed object image. After completing the single correction, the terminal may disable the document correction function. By photographing the photographed object of the document type regarding a single correction in default shooting mode, the terminal can avoid frequent switching in different shooting modes.

Further, after enabling the document correction function, the terminal may perform the quadrangle detection on the preview image of the photographed object if a quadrangle is detected, the terminal performs the single correction on the photographed object image; otherwise, the terminal does not correct the photographed object image after performing photographing. In this way, the terminal may determine, based on a result of the quadrangle detection, whether to directly correct an image, thereby avoiding an incorrect operation.

Optionally, the terminal may further prompt the user to choose whether to enter the document shooting mode, and perform a corresponding operation based on a selection by the user. If the user selects yes, the terminal enters the document shooting mode; otherwise, the terminal maintains the default shooting mode. Further, when the user selects no, the terminal may further prompt the user to choose whether to perform the single correction on the photographed object image. If the user selects yes, the terminal maintains the default shooting mode, and performs a single correction on a to-be-photographed image of a photographed object; otherwise, the terminal maintains the default shooting mode, and does not correct the photographed image of the photographed object. In this way, the terminal can increase interactions with the user, thereby better meeting a requirement of the user on a shooting mode.

In step 205, the terminal maintains the default shooting mode when the photographed object is not of the document type. In default shooting mode, the terminal may not detect the type of the photographed object, or may not correct the photographed image of the photographed object. In this way, the terminal can avoid frequent detection of the type of the photographed object and control system power consumption.

In this embodiment of the present invention, the terminal obtains the preview image of the photographed object when starting the camera, recognizes the preview image, and determines, based on a recognition result, whether the photographed object is of the document type. When the photographed object is of the document type, the terminal can correct the photographed object image in a timely manner; or when the photographed object is not of the document type, the terminal maintains the default shooting mode, thereby avoiding system power consumption caused due to frequent detection of the type of the photographed object, and improving efficiency in photographing and correcting the photographed object of the document type.

### Embodiment 2

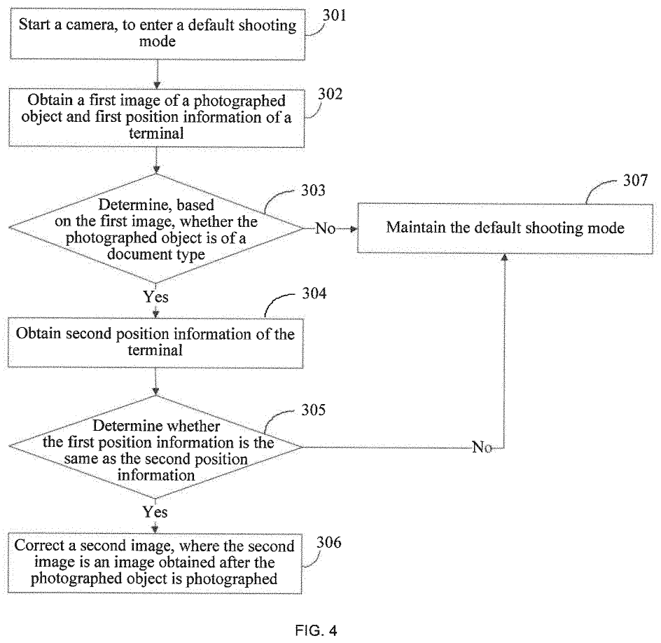

The following describes, with reference to FIG. 4, a second document image correction method provided in this embodiment of the present invention. FIG. 4 is a flowchart of the second document image correction method. The method is performed by a terminal. The method includes the following steps.

Step 301. The terminal starts a camera, to enter a default shooting mode.

Step 302. The terminal obtains a first image of a photographed object and first position information of the terminal.

Step 303. The terminal determines, based on the first image, whether the photographed object is of a document type.

Step 304. When the photographed object is of the document type, the terminal obtains second position information of the terminal.

Step 305. The terminal determines whether the first position information is the same as the second position information.

Step 306. When the first position information is the same as the second position information, the terminal corrects a second image, where the second image is an image obtained after the photographed object is photographed.

Step 307. When the scene type is not a preset scene type, or when the first position information is different from the second position information, the terminal maintains the default shooting mode.

Steps 301, 303, 306, and 307 are respectively similar to steps 201, and 203 to 205, and details are not described herein again. The following specifically describes steps 302, 304, and 305.

In step 302, the terminal obtains the first image of the photographed object and the first position information of the terminal.

The first image may be a preview image obtained by previewing the photographed object by the terminal, or may be a photographed object image obtained by photographing the photographed object by the terminal. For obtaining the preview image by the terminal, refer to the description of step 202. Details are not described herein again. The terminal may photograph the photographed object at any moment after the terminal starts the camera to enter the default shooting mode.

The first position information may be various position data, for example, geographical location coordinates, an altitude, or a building floor number. The terminal may obtain the first position information of the terminal by using the sensor 150 described above.

In step 304, when the terminal determines, based on the first image, that the photographed object is of the document type, the terminal obtains the second position information of the terminal.

The second position information may include information that is of a same type as the first position information. The terminal may obtain the second position information of the terminal by using the foregoing sensor 150 described above. The terminal may obtain the second position information when the terminal restarts or invokes a camera application program in foreground, or during photographing of the photographed object.

In step 305, when the photographed object needs to be corrected, the terminal determines whether the second position information is the same as the first position information. To determine whether the second position information is the same as the first position information, the terminal may calculate a distance between two positions based on the second position information and the first position information, and compare the distance with a predetermined threshold. When the distance is less than or equal to the predetermined threshold, the terminal determines that the second position information is the same as the first position information; otherwise, the terminal determines that the second position information is different from the first position information. The predetermined threshold may be determined based on an actual need. This is not limited in this application.

Optionally, before correcting the second image, the terminal may prompt a user to choose whether to correct the second image, and perform a corresponding operation based on a selection by the user. In this way, interactions between the terminal and the user can be increased, thereby better meeting a user requirement. For example, the terminal may display a dialog box on a screen, to prompt the user to choose whether to correct a document.

Optionally, after completing the correction, the terminal may display a message on the screen, to prompt the user that the image has been corrected. The message may be presented in various manners, for example, by using a notification bar or a message box.

In this embodiment of the present invention, the terminal reduces a quantity of instructions executed during starting of the camera, improves scene detection accuracy by using position information, and can correct the photographed object image in a timely manner, thereby avoiding system power consumption caused due to frequent scene type detection, reducing adverse impact on camera shooting performance, and improving efficiency in photographing and correcting the photographed object of the document type.

### Embodiment 3

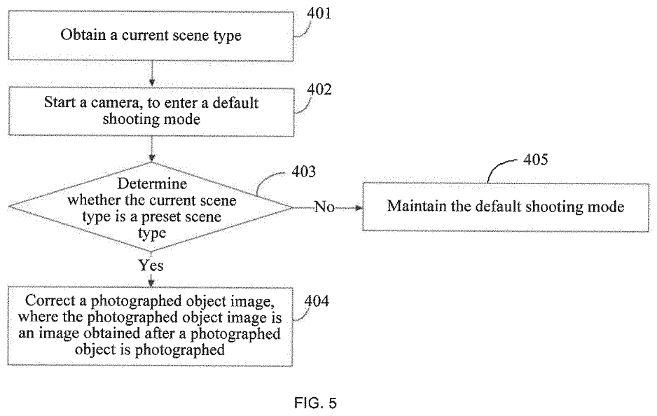

The following describes, with reference to FIG. 5, a third image correction method provided in this embodiment of the present invention. FIG. 5 is a flowchart of the third image correction method. The method is performed by a terminal. The method includes the following steps.

Step 401. The terminal obtains a current scene type.

Step 402. The terminal starts a camera, to enter a default shooting mode.

Step 403. The terminal determines whether the current scene type is a preset scene type.

Step 404. The terminal corrects a photographed object image when the scene type is the preset scene type, where the photographed object image is an image obtained after the photographed object is photographed.

Step 405. The terminal maintains the default shooting mode when the scene type is not the preset scene type.

Steps 402, 404, and 405 are similar to steps 201, 204, and 205, and details are not described herein again. The following describes steps 401 and 403.

In step 401, the current scene type may be a type of a scene in which the terminal is located when photographing the photographed object. When the terminal photographs the photographed object, a user, the photographed object, and the terminal may be in a same scene. Therefore, the type of the scene in which the terminal is located, a type of a scene in which the photographed object is located, and a type of a scene in which the user is located may indicate similar meanings. The terminal may obtain the current scene type by using a sensor.

A scene type includes at least one of the following information: position information, motion state information, environmental sound information, and user schedule information. The position information and the motion state information may be obtained by using the sensor 150 described above. The environmental sound information may be obtained by using the audio circuit 160 described above. Specifically, the environmental sound information may be obtained by using the microphone 162 of the audio circuit 160. The schedule information may be obtained by querying a schedule. The schedule may be a schedule made by the user in a calendar application, or may be a schedule received by the terminal, for example, a schedule received by the terminal by using an email, or a schedule that is received by the terminal and that is shared by another user.

The terminal may start to obtain the current scene type after the terminal is powered on, and in this case, a camera application program does not need to be started; or may start to obtain the current scene type after a camera application program is started, in other words, step 401 may be performed after step 402; or may start to obtain the current scene type based on a user operation. For example, the terminal prompts the user to choose whether to start to obtain a scene type, and if the user selects yes, the terminal starts to obtain the current scene type.

The terminal may obtain the current scene type in real time. In other words, the terminal may continuously or uninterruptedly obtain current scene information. By obtaining the current scene type in real time, the terminal can collect various types of scene information in real time, thereby accurately determining the current scene type.

Alternatively, the terminal may periodically obtain the current scene type. The period may be 30 seconds, one minute, five minutes, 10 minutes, 30 minutes, one hour, or other duration. It may be understood that the period may be set based on an actual need. This is not limited in this application. By periodically obtaining the current scene type, the terminal can control system power consumption caused by continuous turning on of a sensor while collecting various types of scene information. By properly selecting duration of the period, the terminal can accurately determine the current scene.

In step 403, the terminal may determine, based on obtained scene information, whether the current scene type is the preset scene type. The preset scene type may be set based on an actual case, for example, a conference room, a classroom, or a library scene type. It may be understood that the foregoing scene types may alternatively be replaced with other names, for example, a conference, a lecture (or class), or a reading scene type. This is not limited in this application. When the terminal performs photographing in the preset scene type, a photographed object of a document type is usually photographed, for example, a slideshow, a whiteboard, a document, or a book. Therefore, these photographed objects need to be corrected during photographing.

In an example, the terminal may use the position information as a determining dimension, and query, based on the position information, a map database or a position database for a current place type. The terminal determines whether the place type corresponds to the preset scene type. For example, when the place type is a conference center or a conference room, the place type corresponds to a conference room scene; when the place type is a teaching building or a classroom, the place type corresponds to a classroom scene; or when the place type is a library, the place type corresponds to a library scene. When the place type corresponds to the preset scene type, the terminal determines that the current scene type is the preset scene type. For example, when the terminal performs photographing in a conference center, and finds, based on position information, that the place type is a conference center, the terminal determines that the current scene type is a conference room scene and is the preset scene type; or when the terminal performs photographing on a scenery spot, and finds, based on the position information, that the place is a scenic spot, the terminal determines that the current scene type is not the preset scene type.

In another example, the terminal may use schedule information as a determining dimension, and query current schedule information based on a schedule of the user. The terminal determines whether the schedule information corresponds to the preset scene type. When the schedule information corresponds to the preset scene type, the terminal determines that the current scene type is the preset scene type. The schedule information includes conference information, course information, or the like. The terminal may query the current schedule information by extracting time information and a keyword. For example, the schedule on the terminal includes a piece of schedule information: attend a new product release conference 13:30 to 15:00 on February 14 in the National Convention Center. If a current time point is 14:00 (that is, two o'clock in the afternoon) on February 14, by extracting time information and a key word, the terminal can determine that the user is currently attending the conference, and therefore, determine that the current scene type is a conference scene type, and is the preset scene type.

Optionally, the determining, by the terminal, whether the current scene type is the preset scene type includes; determining a confidence level of the current scene type; comparing, by the terminal, the confidence level with a predetermined threshold; and when the confidence level is greater than or equal to the predetermined threshold, determining, by the terminal, that the scene type is the preset scene type; otherwise, determining, by the terminal, that the scene type is not the preset scene type. The confidence level may be used to reflect a degree of credibility at which the current scene type is the preset scene type. The confidence level may be indicated by using different levels, for example, may be indicated by using three levels: high, medium, and low. The predetermined threshold of the confidence level may be determined based on an actual need. When the confidence level is indicated by using the three levels; high, medium, and low, the predetermined threshold may be set to high or medium. Further, the predetermined threshold may be set to high.

In an example, the terminal uses the position information as a basic determining dimension, queries, based on the position information, a map database or a position database for a current place type, and determines whether the place type corresponds to the preset scene type. Then, the terminal uses the motion state information, surrounding environmental sound information, and the schedule information as assistant determining dimensions, determines whether these pieces of information meet a preset condition, and provides the confidence level. The preset condition for the motion state information may be: the terminal detects a static state or a subtle motion. The preset condition for the surrounding environmental sound information may be: a surrounding environmental sound volume of the terminal is less than or equal to a predetermined threshold. For example, the predetermined threshold is 15 dB, 20 dB, or 30 dB. The preset condition for the schedule information may be: the schedule includes schedule information corresponding to the preset scene type, for example, conference information or course information.

When the place type corresponds to the preset scene type and at least two assistant determining dimensions meet the preset condition, the confidence level is high. When the place type corresponds to the preset scene type and any one of the assistant determining dimensions meets the preset condition, the confidence level is medium. When the place type does not correspond to the preset scene type and all the assistant determining dimensions meet the preset condition, the confidence level is medium. When the place type does not correspond to the preset scene type, the confidence level is low.

In another example, the terminal uses schedule information as a determining dimension, and queries current schedule information to determine whether the schedule information corresponds to the preset scene type. Then, the terminal uses the position information, the motion state information, and the surrounding environmental sound information as assistant determining dimensions, determines whether these pieces of information meet a preset condition, and provides the confidence level. The preset condition for the motion state information and the surrounding environmental sound information may be the same as that in the foregoing example. The preset condition for the position information may be: the place type indicated by the position information corresponds to the preset scene type,

When the schedule information corresponds to the preset scene type and at least two assistant determining dimensions meet the preset condition, the confidence level is high. When the schedule information corresponds to the preset scene type and the position information meets the preset condition, the confidence level is high. When the schedule information corresponds to the preset scene type and any assistant determining dimension other than the position information meets the preset condition, the confidence level is medium. When the schedule information does not correspond to the preset scene type and all the assistant determining dimensions meet the preset condition, the confidence level is medium. When the schedule information does not correspond to the preset scene type and the position information does not meet the preset condition, the confidence level is low.

In this embodiment of the present invention, the terminal may perform step 403 before starting the camera. In other words, the terminal may complete determining of the current scene type before starting the camera. Based on a determining result, when the scene type is the preset scene type, the terminal may enable a document correction function described above or enter a document correction mode when starting the camera, so that the terminal can correct the photographed object image after photographing the photographed object. When the scene type is not the preset scene type, the terminal may enter the default shooting mode when starling the camera.

In this embodiment of the present invention, the terminal obtains the current scene type to predict a probability that the user photographs the photographed object of the document type. When the current scene type is the preset scene type, the terminal corrects the photographed object image, thereby improving efficiency in photographing and correcting the photographed object of the document type. Calculation of a confidence level of a predicted scene type can increase determining result accuracy of the scene type. Because the scene type may be obtained outside the camera application program, impact on power consumption caused by the camera application program is relatively small, and shooting performance of the camera is not affected, thereby improving the efficiency in photographing and correcting the photographed object of the document type.

### Embodiment 4

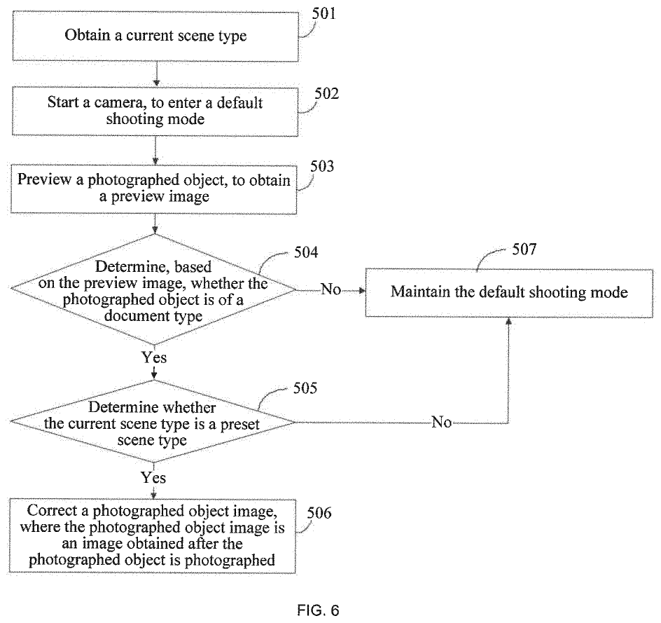

The following describes, with reference to FIG. 6, a fourth document image correction method provided in this embodiment of the present invention, FIG. 6 is a flowchart of the fourth document image correction method. The method is performed by a terminal. The method includes the following steps.

Step 501. The terminal obtains a current scene type.

Step 502. The terminal starts a camera, to enter a default shooting mode.

Step 503. The terminal previews a photographed object, to obtain a preview image.

Step 504. The terminal determines, based on the preview image, whether the photographed object is of a document type.

Step 505. When the photographed object is of the document type, the terminal determines whether the current scene type is a preset scene type.

Step 506. The terminal corrects a photographed object image when the scene type is the preset scene type, where the photographed object image is an image obtained after the photographed object is photographed.

Step 507. When the photographed object is not of the document type, or when the scene type is not the preset scene type, the terminal maintains the default shooting mode.

Steps 502 to 504, 506, and 507 are similar to steps 201 to 205, and steps 501 and 505 are similar to steps 401 and 402. For specific content, refer to the descriptions of the foregoing steps. Details are not described herein again.

It should be noted that a sequence of steps 504 and 505 is not limited in this embodiment of the present invention. The terminal may perform step 504 first, and then perform step 505; or may perform step 505 first, and then perform step 504.

When the terminal performs step 504 first and then performs step 505, based on a determining result obtained by performing step 504 by the terminal, if the photographed object is of the document type, the terminal performs step 505; otherwise, the terminal performs step 507.

When the terminal performs step 505 first and then performs step 504, based on a determining result obtained by performing step 505 by the terminal, if the current scene type is the preset scene type, the terminal performs step 504; otherwise, the terminal performs step 507.

An order in which steps 501 and 505 are performed in this method is not limited in this embodiment of the present invention. The terminal may perform steps 501 and 505 before any one of steps 502 to 504.

In this embodiment of the present invention, the terminal comprehensively determines a type of the photographed object and the current scene type, obtains the preview image of the photographed object when starting the camera, recognizes the preview image, and determines, based on a recognition result, whether the photographed object is of the document type. In addition, the terminal obtains the current scene type to predict a probability that the user photographs the photographed object of the document type, and calculates a confidence level of a predicted scene type, to improve accuracy of a determining result of the scene type. In this way, the terminal can obtain a reliable determining result by jointly using different determining factors, thereby avoiding system power consumption caused due to frequent detection of the type of the photographed object, and improving efficiency in photographing and correcting the photographed object of the document type.

### Embodiment 5

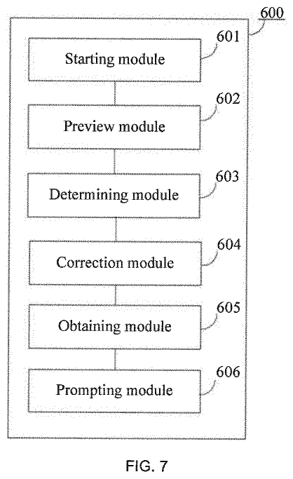

FIG. 7 is a schematic structural diagram of a second terminal according to this embodiment of the present invention. The terminal provided in this embodiment of the present invention may be configured to implement the methods implemented in the foregoing embodiments of the present invention shown in FIG. 3 to FIG. 6. As shown in FIG. 7, the terminal 600 includes a starting module 601, a preview module 602, a determining module 603, and a correction module 604.

The starting module 601 is configured to start a camera, to enter a default shooting mode.

The preview module 602 is configured to preview a photographed object, to obtain a preview image.

The determining module 603 is configured to determine, based on the preview image, whether the photographed object is of a document type.

The correction module 604 is configured to correct a photographed object image when the photographed object is of the document type, where the photographed object image is an image obtained after the photographed object is photographed.

Further, the terminal 600 may include a maintaining module 605. The maintaining module 605 is configured to maintain the default shooting mode when the photographed object is not of the document type.

Further, the correction module 604 is configured to correct the photographed object image when the photographed object is of the document type and the terminal determines that a current scene type is a preset scene type.

Further, the correction module 604 includes a calculation unit and a determining unit. The calculation unit is configured to calculate a confidence level of the current scene type. The determining unit is configured to determine that the current scene type is the preset scene type, when the confidence level is greater than or equal to a predetermined threshold.

Further, the terminal 600 may include an obtaining module 605. The obtaining module 605 is configured to obtain the current scene type. The scene type includes at least one of the following information: position information, motion state information, environmental sound information, or user schedule information.

Further, the obtaining module 605 is configured to periodically obtain the current scene type.

Further, the terminal 600 may include a prompting module 606. The prompting module 606 is configured to: before the terminal corrects the photographed object image, prompt a user to choose whether to correct the photographed object image.

In this embodiment of the present invention, the terminal obtains the preview image of the photographed object when starting the camera, recognizes the preview image, and determines, based on a recognition result, whether the photographed object is of the document type. When the photographed object is of the document type, the terminal can correct the photographed object image in a timely manner; or when the photographed object is not of the document type, the terminal maintains the default shooting mode, thereby avoiding system power consumption caused due to frequent detection of the type of the photographed object and improving efficiency in photographing and correcting the photographed object of the document type.

### Embodiment 6

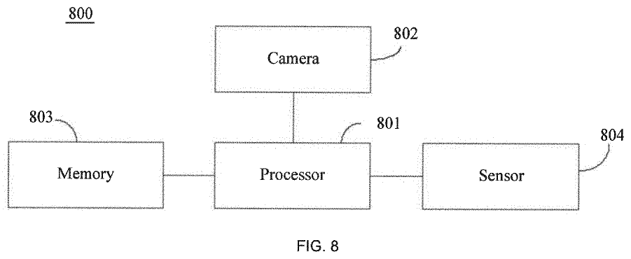

FIG. 8 is a schematic structural diagram of a third terminal according to an embodiment of the present invention. The terminal provided in this embodiment of the present invention may be configured to implement the methods implemented in the foregoing embodiments of the present invention shown in FIG. 3 to FIG. 6. For ease of description, only parts related to this embodiment of the present invention are illustrated. For specific technical details that are not disclosed, refer to the foregoing method embodiments of the present invention and other parts of this application. As shown in FIG. 8, the terminal 800 includes a processor 801, a camera 802, a memory 803, and a sensor 804.

The processor 801 is connected to the camera 802, the memory 803, and the sensor 804 by using one or more buses, and is configured to: receive an image from the camera 802, obtain sensor data collected by the sensor 804 and invoke an executable instruction stored in the memory 803 for processing. The processor 801 may be the processor 180 shown in FIG. 1.

The camera 802 is configured to capture a photographed object image. The camera 802 may be the camera 175 shown in FIG. 1.

The memory 803 may be the memory 120 shown in FIG. 1, or some components in the memory 120.

The sensor 804 is configured to obtain various types of scene information of the terminal. The sensor 806 may be the sensor 150 shown in FIG. 1.

The processor 801 is configured to: start the camera, to enter a default shooting mode; preview a photographed object, to obtain a preview image; determine, based on the preview image, whether the photographed object is of a document type; and correct, by the terminal, a photographed object image when the photographed object is of the document type, where the photographed object image is an image obtained after the photographed object is photographed.

Further, the processor 801 is further configured to maintain the default shooting mode when the photographed object is not of the document type.

Further, the processor 801 is configured to correct the photographed object image when the photographed object is of the document type and the terminal determines that a current scene type is a preset scene type.

Further, the processor 801 is configured to: calculate a confidence level of the current scene type; and determine that the current scene type is the preset scene type, when the confidence level is greater than or equal to a predetermined threshold.

Further, the sensor 804 is configured to obtain the current scene type, where the scene type includes at least one of the following information: position information, motion state information, environmental sound information, or user schedule information.

Further, the sensor 804 is configured to periodically obtain the current scene type.

Further, the processor 801 is configured to: before the terminal corrects the photographed object image, prompt a user to choose whether to correct the photographed object image.

In this embodiment of the present invention, the terminal obtains the preview image of the photographed object when starting the camera, recognizes the preview image, and determines, based on a recognition result, whether the photographed object is of the document type. When the photographed object is of the document type, the terminal can correct the photographed object image in a timely manner; or when the photographed object is not of the document type, the terminal maintains the default shooting mode, thereby avoiding system power consumption caused due to frequent detection of the type of the photographed object, and improving efficiency in photographing and correcting the photographed object of the document type.

All or some of the foregoing embodiments of the present invention may be implemented by using software, hardware, firmware, or any combination thereof. When software is used to implement the embodiments, the embodiments may be implemented completely or partially in a form of a computer program product. The computer program product includes one or more computer instructions. When the computer program instructions are loaded and executed on the computer, the procedure or functions according to the embodiments of the present invention are all or partially generated. The computer may be a general-purpose computer, a dedicated computer, a computer network, or other programmable apparatuses. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (Digital Subscriber Line, DSL)) or wireless (for example, infrared, radio, and microwave, or the like) manner. The computer-readable storage medium may be any usable medium accessible by a computer, or a data storage device, such as a server or a data center, integrating one or more usable media. The usable medium may be a magnetic medium (for example, a soft disk, a hard disk, or a magnetic tape), an optical medium (for example, a digital versatile disc (DVD)), a semiconductor medium (for example, a Solid State Disk (SSD)), or the like.

A person skilled in the art should be aware that in the foregoing one or more examples, functions described in the present invention may be implemented by hardware, software, firmware, or any combination thereof. When the present invention is implemented by software, the foregoing functions may be stored in a computer-readable medium or transmitted as one or more instructions or code in the computer-readable medium. The computer-readable medium includes a computer storage medium and a communications medium where the communications medium includes any medium that enables a computer program to be transmitted from one place to another. The storage medium may be any available medium accessible to a general-purpose or dedicated computer.

In the specific implementations described above, the objects, technical solutions, and beneficial effects of the present invention are further described in detail. Any modification, equivalent replacement, or improvement made without departing from the spirit and principle of the present invention shall fall within the protection scope of the present invention.

1. A document image correction method, comprising:
starting, by a terminal, a camera, to enter a default shooting mode;
previewing, by the terminal, a photographed object, obtain a preview image;
determining, by the terminal based on the preview image, whether the photographed object is of a document type; and
displaying, by the terminal, a dialog box, to prompt the user to choose whether to correct a document:
correcting, by the terminal, a photographed object image when the photographed object is of the document type, wherein the photographed object image is an image obtained after the photographed object is photographed.

2. The method according to claim 1, wherein the method further comprises:
maintaining, by the terminal, the default shooting mode when the photographed object is not of the document type.

3. The method according to claim 1, wherein the correcting, by the terminal, a photographed object image when the photographed object is of the document type comprises:
correcting, by the terminal, the photographed object image when the photographed object is of the document type and the terminal determines that a current scene type is a preset scene type.

4. The method according to claim 3, wherein that the terminal determines that a current scene type is a preset scene type comprises:
determining, by the terminal, a confidence level of the scene type; and
determining, by the terminal, that the current scene type is the preset scene type, when the confidence level is greater than or equal to a predetermined threshold.

5. The method according to claim 1, wherein the method further comprises:
obtaining, by the terminal, the current scene type, wherein
the scene type comprises at least one of the following information: position information, motion state information, environmental sound information, or user schedule information.

6. The method according to claim 5, wherein the obtaining, by the terminal, the current scene type comprises:
periodically obtaining, by the terminal, the current scene type.

7. The method according to claim 1, wherein before the correcting, by the terminal, a photographed object image, the method further comprises:
prompting, by the terminal, a user to choose whether to correct the photographed object image.

8. The method according to claim 1, wherein the preview image is a preview image obtained after the photographed object is focused.

9. The method according to claim 1, wherein the document type comprises: a document, a picture, a contact card, credentials, a book, a slideshow, a whiteboard, a guideboard, or an advertising sign type.

10. The method according to claim 1, wherein the preset scene type comprises a conference room, a classroom, or a library scene type.

11-20. (canceled)

21. A terminal, wherein the terminal comprises a camera, a processor, and a memory, wherein
the processor is configured to: start the camera, to enter a default shooting mode; preview a photographed object, to obtain a preview image; determine, based on the preview image, whether the photographed object is of a document type; and display a dialog box, to prompt the user to choose whether to correct a document: correct a photographed object image when the photographed object is of the document type, wherein the photographed object image is an image obtained after the photographed object is photographed.

22. The terminal according to claim 21, wherein the processor is further configured to maintain the default shooting mode when the photographed object is not of the document type.

23. The terminal according to claim 21, wherein
the processor is configured to correct the photographed object image when the photographed object is of the document type and the terminal determines that a current scene type is a preset scene type.

24. The terminal according to claim 23, wherein
the processor is configured to: calculate a confidence level of the current scene type; and determine that the current scene type is the preset scene type, when the confidence level is greater than or equal to a predetermined threshold.

25. The terminal according to claim 21, wherein
a sensor is configured to obtain the current scene type, wherein
the scene type comprises at least one of the following information: position information, motion state information, environmental sound information, or user schedule information.

26. The terminal according to claim 25, wherein the sensor is configured to periodically obtain the current scene type.

27. The terminal according to claim 21, wherein
the processor is configured to: before the terminal corrects the photographed object image, prompt a user to choose whether to correct the photographed object image.

28. The terminal according to claim 21, wherein the preview image is a preview image obtained after the photographed object is focused.

29. The terminal according to claim 21, wherein the document type comprises: a document, a picture, a contact card, credentials, a book, a slideshow, a whiteboard, a guideboard, or an advertising sign type.

30-32. (canceled)
